(19) United States
(12) Patent Application Publication
(10) Pub. No.: US 2011/0149458 A1
(43) Pub. Date: Jun. 23, 2011

(54) SYSTEMS AND METHODS FOR DETECTING SOLENOID ARMATURE MOVEMENT

(75) Inventors: Philip J. Thomas, Peoria Heights, IL (US); Joseph W. Schumacher, East Peoria, IL (US); William J. Love, Dunlap, IL (US)

(73) Assignee: Caterpillar Inc., Peoria, IL (US)

(21) Appl. No.: 12/640,372

(22) Filed: Dec. 17, 2009

(51) Int. Cl. H01H 47/00

(52) U.S. Cl. 361/160

(57) ABSTRACT

A method for detecting actuation of an armature associated with a solenoid includes providing a voltage potential to a solenoid coil associated with the solenoid. The method also includes measuring a current flowing through the solenoid coil. The method further includes switching the voltage potential off when the measured current reaches a predetermined maximum value. The method also includes switching the voltage potential on when the measured current reaches a predetermined minimum value. The method further includes measuring a chop period between pulses associated with the switching on and off of the voltage potential. The method also includes analyzing successive chop periods to detect armature movement and armature seating. The method further includes determining, based on the comparison of chop periods, a pull-in time of an armature associated with the solenoid.

### TECHNICAL FIELD

The present disclosure relates generally to armature position detectors and, more particularly, to systems and methods for detecting solenoid armature movement.

### BACKGROUND

Solenoids are typically classified as any electromagnetic device that converts electrical energy to linear momentum. Solenoids may include a coil conductor wrapped around a metallic piston that serves as an armature. When voltage is applied to the coil terminals, current is passed through the coil conductor generating an electromagnetic field, which draws the metallic piston toward the field. An electronic controller may be coupled to the solenoid for regulating the flow of current through the coil conductor to control the electromagnetic field.

Position of the piston may be manipulated by controlling the strength of the electromagnetic field. For example, in order to initially actuate the solenoid armature, voltage may be applied across the coil conductor, energizing the coil and strengthening the electromagnetic field associated with the coil. When the electromagnetic force becomes strong enough to overcome the static kinetic forces associated with the armature, the armature is “pulled-in” toward the field. Once the armature has moved to the “pulled-in” position, current in the coil may be reduced to a minimum level required to hold the armature in place (i.e., “hold-in” current). To release the armature, thereby allowing its return to original (i.e., “rested”) state, the current through the coil conductor may be cut-off, allowing the electromagnetic field to dissipate. Once the current level in the coil falls below the “hold-in” current, the electromagnetic forces acting on the armature are no longer sufficient to hold the armature in place, and the armature is returned to its rested state.

In certain situations, it may be beneficial to know when the armature is actuated. For example, in electronic fuel injection systems for combustion engines, fuel-efficient operation of the engine may depend on the precise operation of one or more solenoid valves. Effective determination of the operation of the solenoid valves may depend not only on the time in which the control signals are sent to the solenoid, but on the actuation time of solenoid armatures that may open and close the valves. Thus, a system and method for accurately determining armature movement time may be required.

At least one system has been developed to detect a “drop-off” condition associated with a magnetically operated device. For example, U.S. Pat. No. 6,188,562 (“the '562 disclosure”), which was issued to Lutz et al. on Feb. 13, 2001, describes a method and apparatus for recognizing an accidental closure of a solenoid valve. The system of the '562 disclosure is configured to monitor the frequency of a pulsed hold-in current and determine, based on an increase in the frequency, that an armature associated with the solenoid valve has accidentally dropped off, causing the valve to erroneously close.

Although the system of the '562 disclosure may determine an erroneous or accidental drop-off of a solenoid armature, it may be problematic. For example, because the system may only monitor the frequency of the pulsed signal that supplies the hold-in current to detect accidental drop-off, it may not determine when the actuator returns to its original position after the hold-in current has been turned off. As a result, systems requiring accurate detection of armature movement under normal operating conditions may become inefficient and inaccurate.

Furthermore, the measurement of “pull-in” timing has proven to be problematic. Complex injector designs have made the study of pull-in timing difficult because of noise introduced by several other variables, such as eddy currents, coil resistance, and spring force. Together, these variables and others create forces that oppose electromagnetic force and thus, tend to hold an armature in place when the current is off. Further, these variables produce electromagnetic forces that can cause changes in inductance, previous attempts to measure the pull-in timing have been hampered by noise, such as false seat detections or no seat detection at all. For example strong eddy currents may make changes in inductance nearly undetectable on the current signal being monitored. Likewise, electrical characteristics of a valve may also make chop times so fast that changes in inductance may be hard to detect. Thus, detection methods such as those described in the '562 disclosure unreliable when applied to measuring pull-in timing, as opposed to drop-off timing.

The presently disclosed systems and methods for detecting solenoid armature movement are directed to overcoming one or more of the problems set forth above.

### SUMMARY OF THE INVENTION

In one aspect, a method for detecting actuation of an armature associated with a solenoid, including a step of providing a voltage potential to a solenoid coil associated with the solenoid and substantially concurrently starting a start of current timer. The method also includes a step of measuring a current flowing through the solenoid coil. The method further includes steps of switching the voltage potential off when the measured current reaches a predetermined maximum value and switching the voltage potential on when the measured current reaches a predetermined minimum value. Also included is a step of measuring a chop period between pulses associated with the switching on and off of the voltage potential. A step of analyzing successive chop periods to detect armature movement and armature seating is also included. The method further includes a step of determining armature movement and armature seating times based on the analysis.

In another aspect, an armature actuation detection system, including a power supply selectively coupled to a solenoid coil via one or more switching elements and configured to provide a voltage output. Also included is a controller operatively coupled to the one or more switching elements and configured to operate the one or more switching elements to selectively provide a voltage potential to the solenoid coil and substantially concurrently start a start of current timer. The controller further measures a current flowing through the solenoid coil. The controller is also configured to switch the voltage potential off when the measured current reaches a predetermined maximum value and switch the voltage potential on when the measured current reaches a predetermined minimum value. The controller measures a chop period between pulses of the voltage potential and analyzes successive chop periods to detect armature movement and armature seating. The controller further determines armature movement and armature seating times based on the analysis.

In another aspect, a machine, including a solenoid having a conductor and an armature, wherein the conductor is coiled substantially around the armature in a longitudinal direction and separated from the armature via an air gap, the armature being adapted to move relative to the conductor in the presence of an electromagnetic field generated by the conductor. The machine further includes an armature actuation detection system operatively coupled to the solenoid, the armature actuation detection system including a power supply selectively coupled to a solenoid conductor via one or more switching elements and configured to provide a voltage output. The armature detection actuation system further includes a controller operatively coupled to the one or more switching elements and configured to operate the one or more switching elements to selectively provide a voltage potential to the solenoid conductor and substantially concurrently start a start of current timer. The controller also measures a current flowing through the solenoid conductor. The controller also switches the voltage potential off when the measured current reaches a predetermined maximum value and switches the voltage potential on when the measured current reaches a predetermined minimum value. The controller measures a chop period between pulses of the voltage potential. The controller analyzes successive chop periods to detect armature movement and armature seating. The controller also determines armature movement and armature seating times based on the analysis.

### BRIEF DESCRIPTION OF THE DRAWINGS

FIG. 1 provides a diagrammatic illustration depicting an exemplary machine in accordance with certain disclosed embodiments;

FIG. 2 provides a block diagram illustration of an exemplary armature movement detection system in accordance with the disclosed embodiments;

FIG. 3 provides a graph illustrating solenoid coil voltage and current with respect to time in accordance with the disclosed embodiments;

FIG. 4 provides a flowchart depicting an exemplary method for detecting actuation of a solenoid armature consistent with certain disclosed embodiments;

FIG. 5 provides an graph illustrating measured time between pulses; and

FIG. 5a depicts a circular buffer algorithm corresponding to the points in the graph illustrated in FIG. 5

### DETAILED DESCRIPTION

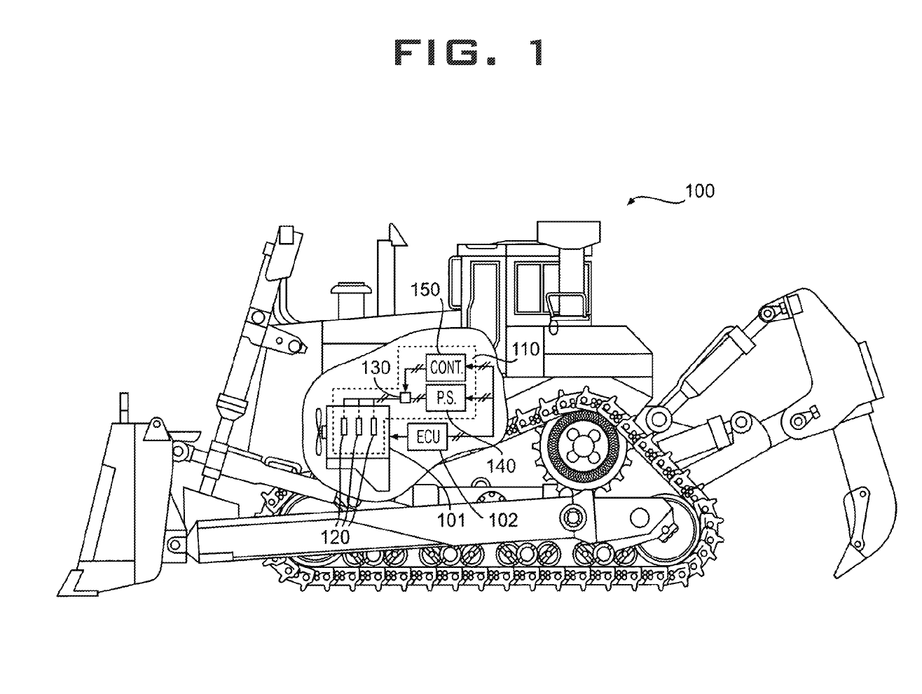

FIG. 1 provides a diagrammatic illustration of an exemplary machine 100 according to certain disclosed embodiments. Machine 100 may include any fixed or mobile machine for performing a task associated with an industry such as mining, construction, farming, transportation, power generation, manufacturing, and any other type of industry. Non-limiting examples of fixed machines include engine systems, turbines, power generators, stationary drill equipment (e.g., for an off-shore drill platform), and any other types of fixed machines. Non-limiting examples of mobile machines include cranes, haulers, front end loaders, tractors, on and off-highway vehicles, automobiles, excavators, dump trucks, or any other suitable mobile machine. Machine 100 may include, among other things, a power source 101 for producing a power output, an electronic control unit (ECU) 102, one or more solenoids 120 configured to perform at least one task associated with machine 100, and a system 110 for detecting movement of an armature associated with solenoid 120. Although machine 100 is illustrated as a track-type tractor machine, it is contemplated that machine 100 may include any suitable type of mobile or fixed machine, such as those described above.

Power source 101 may include any device configured to output energy for use by machine 100. For example, power source 101 may include a combustion engine configured to operate on diesel fuel, gasoline, natural gas, or any other type of fuel. Alternatively and/or additionally, power source 101 may include any type of device configured to output electrical and/or mechanical energy such as, for example, a fuel cell, a generator, a battery, a turbine, an alternator, a transformer, or any other appropriate power output device.

ECU 102 may be coupled to a plurality of subsystems and components associated with machine 100 and configured to monitor and control operations associated with these systems and components. For example, ECU 102 may be operatively coupled to power source 101 and configured to control operations associated with subsystems and components associated with power source 101. Alternatively and/or additionally, ECU 102 may be communicatively coupled to system 110 and configured to monitor and control the operation of one or more solenoids 120 of machine 100. Although ECU 102 is illustrated as a control unit for machine 100, ECU 102 may include any type of control system such as, for example, a powertrain control module (PCM) associated with an automobile, a controller associated with a piece of manufacturing equipment, or any other suitable system that may be adapted to monitor and/or control an operational aspect associated with machine 100.

One or more solenoids 120 may each include an electromechanical transducer configured to convert electrical energy to linear momentum for actuating at least one mechanical device associated with machine 100. For example, solenoid 120 may be configured as an electromechanical valve, relay, switch, or other suitable device that may be configured to provide mechanical output power based on an electrical power input. For example, solenoid 120 may include one or more valves configured to regulate the flow of fuel to a combustion chamber. Alternatively, solenoid 120 may include a starter motor switch configured to facilitate a current flow to energize a starter motor associated with machine 100. Alternatively and/or additionally, it is contemplated that one or more solenoids 120 may be implemented in any application associated with machine 100 where electronic control of mechanical actuators may be required.

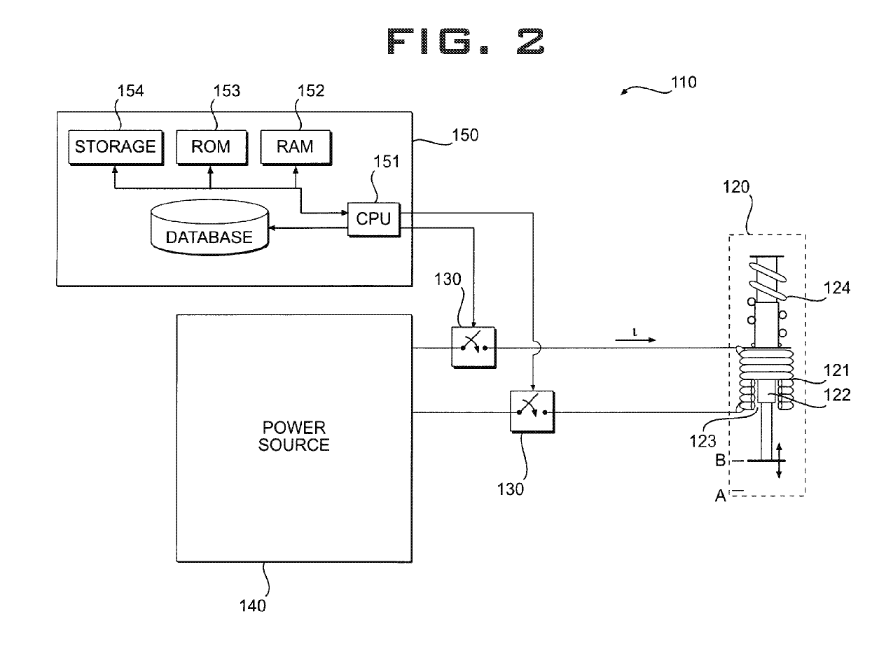

As illustrated in FIG. 2, solenoid 120 may include one or more components configured to receive electrical power input and provide mechanical power output in response to the power input. For example, solenoid 120 may include a solenoid coil 121 selectively coupled to an armature 122 and separated from armature 122 via air gap 123. Solenoid 120 may also include a positioner 124 for positioning armature 122 in an initial (or original) state (denoted by position “A”) when no electromagnetic field is present within air gap 123.

Solenoid coil 121 may include any type of metallic conductor and may be configured in a substantially coiled arrangement. This coiled arrangement may facilitate the induction of an electromagnetic field substantially around the coil, with the strongest field contained within the area associated with a perimeter created by the coil. Solenoid coil 121 may include copper, aluminum, steel, nickel, iron or any other suitable metallic or metallic-alloy wire that may be used to induce a magnetic field associated with a passage of current through the wire.

Armature 122 may be disposed substantially longitudinally within the coiled conductor and configured to move relative to solenoid coil 121 in the presence of an electromagnetic field generated by a current passing through the coil. For example, armature 122 may be configured to move from an original position “A” to a “pulled-in” position “B” in the presence of an electromagnetic field provided by solenoid coil 121. Movement of armature 122 may be proportional to the strength of the electromagnetic field and may be substantially in the direction of flow of current through the solenoid coil 121. Armature 122 may be constructed of any high magnetic permeability material such as, for example, iron, nickel, cobalt, or any other suitable high-permeability metal or metal-alloy.

As illustrated in FIG. 2, solenoid 120 may be selectively coupled to a system 110 for detecting armature movement. System 110 may include one or more components configured to control solenoid 120, monitor one or more operational aspects associated with solenoid 120, and determine when armature 122 associated with solenoid 120 has changed positions. System 110 may include, among other things, a power supply 140 selectively coupled to solenoid 120 via one or more switching elements 130 and a controller 150 for monitoring and controlling operations of system 110.

Power supply 140 may include any device for providing an electrical power output for use by solenoid 120. Power supply 140 may include, for example, a generator, an alternator, a battery, a fuel cell, a transformer, a power converter, or any other suitable device for providing AC or DC power for use by solenoid 120. Power supply 140 may constitute a standalone source of electrical power configured to provide power to multiple electrical systems or components associated with machine 100. Alternatively, power supply 140 may be included within controller 150 as an integrated unit dedicated exclusively for use by controller 150.

Switching elements 130 may include one or more components configured to selectively couple power supply 140 to solenoid 120. Switching elements 130 may include any type of mechanical or electrical switch such as, for example, a solid-state transistor type switch (e.g., FET switch, BJT switch, CMOS switch, IGBT switch, etc.), a relay device, a circuit breaker or any other device suitable for selectively coupling power supply 140 to solenoid 120. Switching elements 130 may be electronically operated by a control unit, such as ECU 102 or controller 150.

Controller 150 may include any type of processor-based system on which processes and methods consistent with the disclosed embodiments may be implemented. Controller 150 may include one or more hardware components such as, for example, a central processing unit (CPU) 151, a random access memory (RAM) module 152, a read-only memory (ROM) module 153, a storage 154, and a database 155. Alternatively and/or additionally, controller 150 may include one or more software components such as, for example, a computer-readable medium including computer-executable instructions for performing methods consistent with certain disclosed embodiments. It is contemplated that one or more of the hardware components listed above may be implemented using software. For example, storage 154 may include a software partition associated with one or more other hardware components of controller 150. Controller 150 may include additional, fewer, and/or different components than those listed above. It is understood that the components listed above are exemplary only and not intended to be limiting.

CPU 151 may include one or more processors, each configured to execute instructions and process data to perform one or more functions associated with controller 150. As illustrated in FIG. 2, CPU 151 may be communicatively coupled to RAM 152, ROM 153, storage 154, and database 155. CPU 151 may be configured to execute sequences of computer program instructions to perform various processes, which will be described in detail below. The computer program instructions may be loaded into RAM 152 for execution by CPU 151.

RAM 152 and ROM 153 may each include one or more devices for storing information associated with an operation of controller 150 and/or CPU 151. For example, ROM 153 may include a memory device configured to access and store information associated with controller 150, including information for identifying, initializing, and monitoring the operation of one or more components and subsystems of controller 150. RAM 152 may include a memory device for storing data associated with one or more operations of CPU 151. For example, ROM 153 may load instructions into RAM 152 for execution by CPU 151.

Storage 154 may include any type of mass storage device configured to store information that CPU 151 may need to perform processes consistent with the disclosed embodiments. For example, storage 154 may include one or more solid state, magnetic, and/or optical disk devices, such as hard drives, CD-ROMs, DVD-ROMs, or any other type of mass media device.

Database 155 may include one or more software and/or hardware components that cooperate to store, organize, sort, filter, and/or arrange data used by controller 150 and/or CPU 151. For example, database 155 may include one or more predetermined threshold levels associated with current maximum and minimums associated with various operational states of solenoid 120. For example, database 155 may include one set of current maximum and minimum threshold levels associated with a pull-in state of operation. Additionally, database 155 may include a second set of current maximums and minimum threshold levels associated with a hold-in state of operation. Database 155 may also include a third set or current maximum and minimum threshold levels associated with a drop-off state of operation. Each of these operational states will be described in greater detail below. CPU 151 may access the information stored in database 155 for comparing a measured solenoid coil current with one or more of the threshold levels to determine if/when to operate one or more switching elements 130 associated with system 110. It is contemplated that database 155 may store additional and/or different information than that listed above.

Controller 150 may be communicatively coupled to switching elements 130 and configured to operate each of switching elements 130. Controller 150 may operate switching elements 130 based on a desired operation of solenoid 120. For example, controller 150 may operate switching elements 130 to pulse the energy provided by power supply 140 to solenoid coil 121, thereby providing a variable current flow through solenoid coil to generate a magnetic field for actuating armature 122. Controller 150 may be configured to manipulate this variable current flow by sequentially operating one or more switching elements 130 to produce an electromagnetic field associated with solenoid 120 based on a desired operation of solenoid 120.

Controller 150 may also be communicatively coupled to power supply 140 to control a power level of a power output associated with power supply 140. For example, for a pull-in state associated with solenoid 120, controller 150 set a power level associated with power supply 140 to a first power level. Once pull-in has been achieved, controller 150 may vary the power level based on a desired operation of solenoid 120. In addition to power level, controller 150 may be configured to adjust other operational aspects associated with power supply 140 such as, for example, frequency, waveform, etc.

Controller 150 may be configured to monitor one or more operational aspects associated with system 110. For example, controller 150 may include one or more monitoring devices (not shown) operatively coupled to a portion of system 110. These monitoring devices may include one or more current and/or voltage sampling devices configured to monitor a current or voltage level associated with solenoid coil 121, a timing counter configured to monitor a time between operation of the one or more switching elements 130, or any other suitable device for monitoring an operational aspect associated with system 110.

Controller 150 may be configured to operate one or more switching elements 130 and/or power supply 140 to energize solenoid coil 121 based on a desired operation of solenoid 120. For example, at an initial time, controller 150 may place one or more switching elements 130 in an “off” state, corresponding to a state where the switching element is not conducting current. As a result, the circuit providing the current flow path through solenoid coil 121 may be open, preventing current flow and, therefore, preventing an induction of a magnetic field associated with solenoid coil 121. Without the presence of a magnetic force, solenoid armature 122 may be held in rested in an initial state “A” by positioner 124, which may include an electrical or mechanical element, such as a spring, a magnet, or any other type of element for holding and/or returning armature 122 to initial state “A.”

It is contemplated that, in addition to placing one or more switching elements 130 in an “off” state, thereby preventing current flow between power supply 140 and solenoid 120, controller 150 may, controller 150 may place one or more switching elements in a “reduced” state, thereby reducing and/or minimizing the current flow to a predetermined level. Thus, it is contemplated that placing one or more switching elements 130 in an “off” state refers to any activity that substantially reduces the current flow from a first state to a second state wherein the electromagnetic field induced by the solenoid coil is allowed to dissipate.

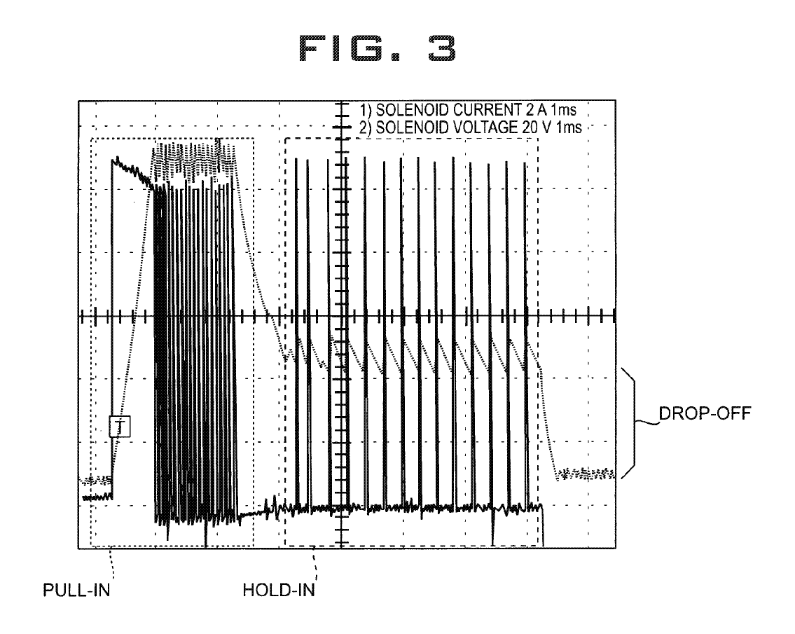

FIG. 3 provides current and voltage flow illustrations associated with solenoid coil 121 during an exemplary operation of solenoid 120. As illustrated in FIG. 3, controller 150 may initiate operation of solenoid 120 by placing each of switching elements 130 lying in the solenoid circuit in an “on” state, enabling the flow of energy between power supply 140 and solenoid 120 through solenoid coil 121. In addition to placing switching elements 130 “on”, controller 150 may set power supply maximum and minimum voltage levels based on predetermined pull-in voltage associated with solenoid 120. This pull-in voltage may include a minimum voltage level required to provide solenoid coil 121 with a current level large enough to induce a magnetic field with enough force to “pull” armature 122 from its initial position “A” to a pulled-in position “B”.

Due to the inductive nature of solenoid coil 121, controller 150 may be configured to sequentially pulse one or more switching elements 130 off and on in order to provide the variable current that may be required to induce the magnetic field. Controller 150 may pulse this voltage at a predetermined frequency. Alternatively, according to one embodiment, controller 150 may initially energize the current to a maximum current level. Once the solenoid coil current reaches this maximum level, controller 150 may place one or more switching devices 130 in an off state, allowing some of the current stored in solenoid coil 121 to dissipate. When the current dissipates to a minimum threshold level, controller 150 may place the switches in the on state, thereby enabling current to re-charge solenoid coil 121.

Once the current in the coil has induced a magnetic field strong enough to overcome the initial force, armature 122 may actuate by moving from position “A” to position “B”. It should be noted that the movement of armature 122 from position “A” to position “B” may result in a change in the inductance associated with solenoid coil 121. As a result of this change, the armature movement may induce a small current that acts in the opposite direction of the current induced by the application of pull-in voltage. This negative current flow may cause an increase in the time required for the solenoid coil current to reach its maximum threshold value.

Once armature 122 has been successfully pulled in, controller 150 may set the maximum and minimum voltage levels associated with power supply 140 to a predetermined hold-in value. Because less energy may be required to hold armature 122 in position “B” than was required to pull-in armature 122, the hold-in value may include a minimum voltage level that is considerably less than the pull-in voltage level. This hold-in value may correspond to a minimum voltage level required to provide solenoid coil 121 with a current that induces a magnetic field with enough force to hold armature in position “B”.

To release armature 122 and allow it to return to its original state (i.e., position “A”), controller 150 may place one or more switching devices 130 in the “off” state, and allow the current associated with solenoid coil 121 to fall below the hold-in value. As the current associated with solenoid coil 121 dissipates, the electromagnetic field induced by the current weakens until the initial force (as provided by positioner 124) overcomes the force of the electromagnetic field that holds armature 122 at hold-in position “B”, allowing armature 122 to “drop-off” and return to position “A”. The movement of armature 122 from position “B” to its original position “A” may result in a change in the inductance of solenoid coil 121. This change may induce a supplemental current within solenoid coil 121, which may flow in the same direction as the current induced by the application of the pull-in current. This positive current flow may increase the time that may be required for the current to dissipate from solenoid coil 121.

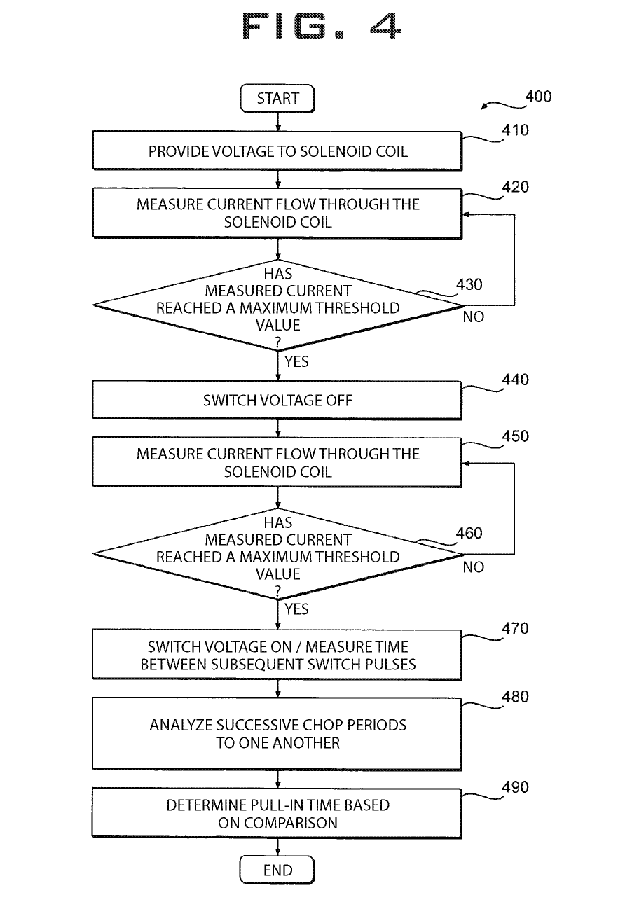

Processes and methods consistent with the disclosed embodiments may enable systems that rely on precise control of solenoid 120 to accurately determine when armature 122 actuates (i.e., when armature 122 “pulls-in” and “drops-off”). FIG. 4 provides a flowchart 400 illustrating an exemplary method for operating system 110 associated with controller 150.

As illustrated in FIG. 4, the method include providing voltage to solenoid coil 121 associated with solenoid 120 (Step 410). For example, controller 150 may adjust the maximum and minimum voltage threshold levels to provide the appropriate pull-in voltage to solenoid coil 121 and place switching elements 130 in the “on” state. As a result, the pull-in voltage may be applied across solenoid coil 121, enabling current flow therethrough.

Once voltage has been provided to solenoid coil 121, the current flowing through solenoid coil 121 may be measured (Step 420). For example, controller 150 may include one or more current monitoring devices configured to automatically monitor the current flow associated with solenoid coil 121. Controller 150 may be configured to continuously monitor the solenoid coil current. Alternatively, controller 150 may sample the solenoid coil current periodically, based on a predetermined sampling rate.

Controller 150 may compare the measured current associated with solenoid coil 121 to a maximum current threshold value (Step 430). For example, CPU 151 of controller 150 may compare the measured current with a predetermined maximum current threshold value stored in database 155. If the solenoid coil current has not reached this maximum threshold value, controller 150 may continue monitoring the coil current (Step 430: No). Alternatively, if the solenoid coil current has reached the maximum threshold value, controller 150 may place one or more switching devices in the “off” state, thereby cutting off the supply voltage to solenoid coil 121 and allowing the solenoid coil current to dissipate (Step 440).

While the solenoid coil current dissipates, controller 150 may measure the solenoid coil current (Step 450) and compare the measured current to a minimum threshold value (Step 460). For example, CPU 151 associated with controller 150 may compare the measured solenoid coil current with a predetermined minimum threshold value stored in database 155. If the solenoid coil current has not dissipated to a minimum threshold level, controller 150 may continue measuring the current flow through solenoid coil 121 (Step 460: No).

Alternatively, if the solenoid coil current has dissipated to a minimum threshold level (Step 460: Yes), controller 150 may place switching devices 130 in the “on” state and measure the chop period between the switching on and off of switching devices 130 (Step 470). For example, CPU 151 associated with controller 150 may provide control signals to turn on switching devices 130. Chop period may also be measured as the time elapsed between the switching on and switching off of switching devices 130 in subsequent operations of switching devices 130. Alternatively, the chop period may also be measured as the time 1) from the switching the voltage potential on, then off, and then back on again; 2) from switching the voltage potential off, then on, and then back off again; or 3) from switching the voltage potential off to on. CPU 151 may store the measured chop period in storage 154 for future analysis.

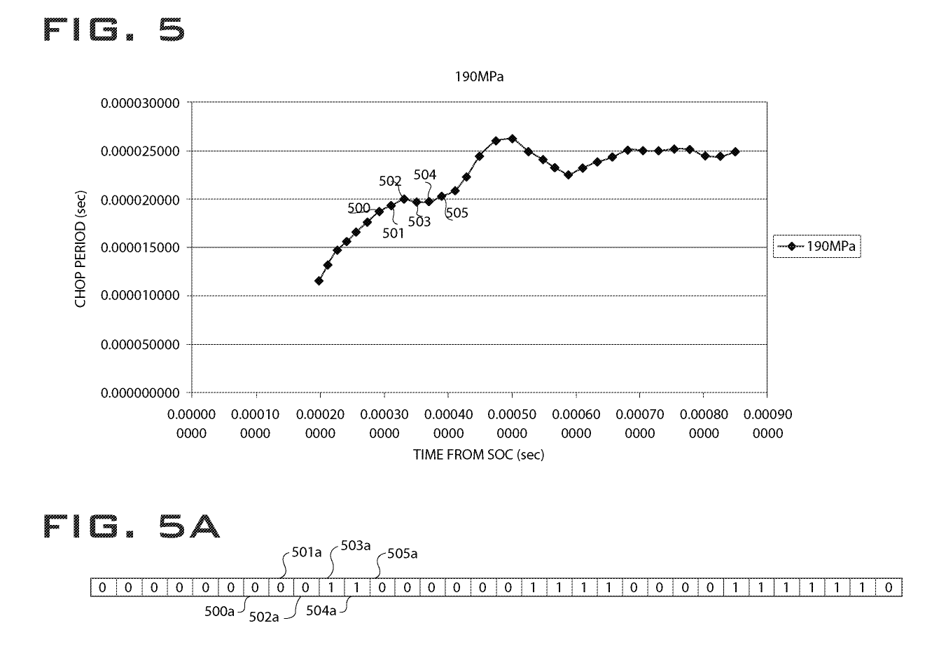

Once the chop period associated with the voltage pulses of the solenoid coil 121 has been measured, controller 150 may analyze successive chop periods to detect armature movement (Step 480). For example, controller 150 may analyze a plurality of successive chop periods. Specifically, the controller may use a circular buffer type algorithm to compare the chop period of a current chop with that of a previous chop. FIG. 5 shows an exemplary curve that may be drawn when chop period is plotted against time from the start of current. Armature movement may be determined by identifying local maximums. A circular buffer algorithm, such as that shown in FIG. 5a may be used to identify such maximums.

FIG. 5a depicts a table showing a visual representation of how a circular buffer would operate. The spaces in the table correspond with each point plotted in FIG. 5. A “zero” or “one” value is assigned to each space depending on the following rules: 1) If the chop period (y-value) of a particular point is greater than the chop period of a point measured immediately prior thereto, a value of zero is assigned. 2) If the chop period (y-value) of a particular point it less than or equal to the chop period of a point measured immediately prior thereto, a value of one is assigned. By analyzing each successive point using a circular buffer algorithm, a localized maximum may be determined when, at one point the buffer is assigned a zero and at the immediately successive point, the buffer is assigned a one value. For example, reference numerals 500-505 represent six points on the curve shown in FIG. 5. Likewise, as shown in FIG. 5a, reference numerals 500a-505a represent corresponding values plotted in a circular buffer according to the aforementioned rules. The point referenced by 502 is a local maximum. This can be seen on FIG. 5 as it has a greater y-value than the points immediately prior and successive thereto. Similarly, as depicted in the circular buffer, the spaces associated with points 502a and 503a are where the table goes from a zero to a one value. In other words, the chop value at point 502 is higher than that of point 501; and the chop value at point 503 is less than or equal to that of 502. Thus, point 502 is a local maximum. In the curve shown in FIG. 5, point 502 is where the armature begins to move.

A controller can repeatedly use a circular buffer algorithm such as that depicted in FIG. 5a to continuously monitor the position of the armature. For example, once the end of the table is reached, the controller may start over again at the beginning and reuse each space by overwriting it with a new zero or one value. Those skilled in the art will recognize that the circular buffer may contain any number of spaces so long as the aforementioned rules for populating the spaces are adhered to.

By being able to continuously measure armature movement, pull-in movement in particular, in a manner as described above, significant controller memory resources may be conserved. Previous methods to determine pull-in time required a comparison of the points plotted in FIG. 5 with an ideal inductance curve for a particular solenoid 121. The comparison determined the armature movement by calculating the point where the curve of FIG. 5 was at its maximum deviation from the ideal inductance curve. In order to utilize this method, the data for the ideal inductance curve must be stored in the computer database 155 at all times. The present disclosure, on the other hand can calculate the pull-in time “on the fly” without having to compare it with voluminous inductance curve data. In so doing, significant database resources may be conserved.

Those skilled in the art will recognize that alternative ways to determine localized maximums may be employed without departing from the scope of this disclosure. For example, the controller 150 may be configured to calculate a polynomial formula for curve represented by points plotted in FIG. 5. By taking a derivative of this curve, localized maximums may be determined. Furthermore, as with the circular buffer algorithm described herein the controller 150 may determine movement of the armature, or specifically pull-in times without having to expend additional storage resources as were required with previous methods.

### INDUSTRIAL APPLICABILITY

The disclosed armature movement detection system may be applicable to any system where accurate and reliable determination of armature movement in electromagnetic transducers may be advantageous. Specifically, the disclosed armature movement detection system may provide a method for determining a pull-in time and drop-off time of a solenoid actuator, both of which may be critical in systems that rely on the precision control of solenoid operations.

The presently disclosed armature movement detection system may provide several advantages. For example, system 110 may be configured to determine a drop-off time associated with a solenoid armature after the hold-in voltage has been cut-off As a result, a pulsed test voltage may be applied to solenoid 120, enabling system 110 to more accurately determine the drop-off time associated armature 122 than conventional systems that monitor current variations in solenoid coil, which may be difficult to detect.

In addition, the presently disclosed armature movement detection system may enhance control capabilities of systems associated with machine 100. For example, the ability to determine both pull-in time and drop-off time may enable system 110 to more accurately control the actuation of armature 122, by allowing the system to account for any lag in armature movement due to the buildup of the magnetic field. As a result, systems that rely on precise control of armature actuation (such as fuel injection systems, for example) may become more efficient.

It will be apparent to those skilled in the art that various modifications and variations can be made to the disclosed solenoid armature movement detection system without departing from the scope of the invention. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for detecting actuation of an armature associated with a solenoid, comprising:
providing a voltage potential to a solenoid coil associated with the solenoid and substantially concurrently starting a start of current timer;
measuring a current flowing through the solenoid coil;
switching the voltage potential off when the measured current reaches a predetermined maximum value;
switching the voltage potential on when the measured current reaches a predetermined minimum value;
measuring a chop period associated with the switching off and switching on of the voltage potential;
analyzing successive chop periods to detect armature movement and armature seating; and
determining armature movement and armature seating times based on the analysis.

2. The method of claim 1, wherein the analyzing step includes logging successive data points on a graph where time from the start of current is measured on the x-axis, and chop period is measured on the y-axis.

3. The method of claim 2, wherein the analyzing step further includes comparing the value of successive chop periods to one another.

4. The method of claim 3, wherein the determination step further includes identifying movement of the armature as a point in time wherein the value of a succeeding chop period is less than or equal to an immediately preceding chop period.

5. The method of claim 3, wherein the determination step further includes determining a pull-in time as a time wherein the value of the chop period is at its absolute maximum.

6. The method of claim 1, wherein measuring the chop period measures the time between switching the voltage potential on and switching the voltage potential off.

7. The method of claim 1, wherein measuring the chop period measures the time elapsed between switching the voltage potential off and switching the voltage potential on.

8. The method of claim 1, wherein measuring the chop period measures the time elapsed between switching the voltage potential on, switching the voltage potential off, and switching the voltage potential back on again.

9. The method of claim 1, wherein measuring the chop period measures the time elapsed between switching the voltage potential off, switching voltage potential on, and switching the voltage potential back off again.

10. An armature actuation detection system, comprising:
a power supply selectively coupled to a solenoid coil via one or more switching elements and configured to provide a voltage output;
a controller operatively coupled to the one or more switching elements and configured to:
operate the one or more switching elements to selectively provide a voltage potential to the solenoid coil and substantially concurrently start a start of current timer;
measure a current flowing through the solenoid coil;
switch the voltage potential off when the measured current reaches a predetermined maximum value;
switch the voltage potential on when the measured current reaches a predetermined minimum value;
measure a chop period between pulses of the voltage potential;
analyze successive chop periods to detect armature movement and armature seating; and
determine armature movement and armature seating times based on the analysis.

11. The system of claim 10, wherein the controller includes an electronic control unit associated with a machine.

12. The system of claim 10, wherein the analysis of successive chop periods further includes logging successive data points on a graph where time from the start of current is measured on the x-axis, and chop period is measured on the y-axis.

13. The system of claim 12, wherein the analysis of successive chop periods further includes comparing the value of successive chop periods to one another

14. The system of claim 13, wherein the analysis of successive chop periods further includes identifying movement of the armature as a point in time wherein the value of a succeeding chop period is less than or equal to an immediately preceding chop period.

15. The system of claim 13, wherein the determination of armature movement further includes determining a pull-in time as a time wherein the value of the chop period is at its absolute maximum.

16. The system of claim 10, wherein the controller is further configured to measure the chop period between pulses as a time between switching the voltage potential off and switching the voltage potential on.

17. The system of claim 10, wherein measuring the chop period measures the time between switching the voltage potential off and switching the voltage potential on.

18. The system of claim 10, wherein the controller is further configured to measure the chop period between pulses as a time elapsed between switching the voltage potential on, switching the voltage potential off, and switching the voltage potential back on again.

19. The system of claim 10, wherein the controller is further configured to measure the chop period between pulses as a time elapsed between switching the voltage potential off, switching the voltage potential on, and switching the voltage potential back off again.

20. A machine, comprising:
a solenoid having a conductor and an armature, wherein the conductor is coiled substantially around the armature in a longitudinal direction and separated from the armature via an air gap, the armature being adapted to move relative to the conductor in the presence of an electromagnetic field generated by the conductor;
an armature actuation detection system operatively coupled to the solenoid, the armature actuation detection system including:
a power supply selectively coupled to a solenoid conductor via one or more switching elements and configured to provide a voltage output;
a controller operatively coupled to the one or more switching elements and configured to:
operate the one or more switching elements to selectively provide a voltage potential to the solenoid conductor and substantially concurrently start a start of current timer;
measure a current flowing through the solenoid conductor;
switch the voltage potential off when the measured current reaches a predetermined maximum value;
switch the voltage potential on when the measured current reaches a predetermined minimum value;
measure a chop period between pulses of the voltage potential;
analyze successive chop periods to detect armature movement and armature seating; and
determine armature movement and armature seating times based on the analysis.

21. The machine of claim 20, wherein the controller includes an electronic control system associated with a machine.

22. The machine of claim 20, wherein the analysis of successive chop periods further includes logging successive data points on a graph where time from the start of current is measured on the x-axis, and chop period is measured on the y-axis.

23. The machine of claim 21, wherein the analysis of successive chop periods further includes comparing the value of successive chop periods to one another

24. The machine of claim 22, wherein the analysis of successive chop periods further includes identifying movement of the armature as a point in time wherein the value of a succeeding chop period is less than or equal to an immediately preceding chop period.

25. The machine of claim 22, wherein the determination of armature movement further includes determining a pull-in time as a time wherein the value of the chop period is at its absolute maximum.

26. The machine of claim 20, wherein the controller is further configured to measure the chop period between pulses as a time elapsed switching the voltage potential off and switching the voltage potential on.

27. The machine of claim 20, wherein measuring the chop period measures the time elapsed between switching the voltage potential off and switching the voltage potential on.

28. The machine of claim 20, wherein the controller is further configured to measure the chop period between pulses as a time elapsed between switching the voltage potential on, switching the voltage potential off, and switching the voltage potential back on again.

29. The machine of claim 20, wherein the controller is further configured to measure the chop period between pulses as a time elapsed between switching the voltage potential off, switching the voltage potential on, and switching the voltage potential back off again.
